(19) United States
(12) Patent Application Publication
(10) Pub. No.: US 2026/0299614 A1
(43) Pub. Date: Oct. 1, 2026

(54) CONTROL METHOD OF MOVABLE BODY, CONTROL DEVICE, MOVABLE BODY, AND STORAGE MEDIUM

(71) Applicant: HONDA MOTOR CO., LTD., Tokyo (JP)

(72) Inventors: Sango MATSUZAKI, Wako-shi (JP); Misa KOMURO, Wako-shi (JP)

(21) Appl. No.: 19/570,666

(22) Filed: Mar. 18, 2026

(30) Foreign Application Priority Data
Mar. 31, 2025 (JP) 2025-058996

(51) Int. Cl. G05D 1/686; G05D 1/246; G05D 1/622; G05D 1/644; G05D 105/70; G05D 109/10; G05D 111/10; G06T 7/10; G06T 7/70; G06V 10/26; G06V 40/16

(52) U.S. Cl. CPC G05D 1/686; G05D 1/2464; G05D 1/622; G05D 1/644; G06T 7/10; G06T 7/70; G06V 10/273; G06V 40/172; G05D 2105/70; G05D 2109/10; G05D 2111/10; G06T 2207/30196

(57) ABSTRACT

A control method of a movable body that moves together with a specific person, includes recognizing the specific person and another pedestrian in pedestrians in surroundings of the movable body by using an image; and, in response to being incapable of recognizing the specific person in another image, predicting a future position of a first candidate with respect to the movable body, the first candidate being in the pedestrians in the surroundings of the movable body; and controlling traveling of the movable body to move from a current position to a specific position for recognizing the first candidate in accordance with the future position predicted of the first candidate.

### CROSS-REFERENCE TO RELATED APPLICATION(S)

This application claims priority to and the benefit of Japanese Patent Application No. 2025-058996, filed Mar. 31, 2025, the entire disclosure of which is incorporated herein by reference.

### BACKGROUND OF THE INVENTION

### Field of the Invention

The present invention relates to a control method of a movable body, a control device, a movable body, and a storage medium.

### Description of the Related Art

A movable body such as a robot that follows or leads a user, and that autonomously travels is known. JP 2022-059972 A discloses a technique of causing a robot to travel ahead of a specific person (an object to be guided) that has been recognized beforehand in order to guide such a specific person, and when the robot fails to recognize the specific person using face tracking or human body tracking processing, reducing a moving speed to recognize the specific person again.

In the above-described related art, the moving speed of the movable body is reduced, and then if the specific person happens to appear in an image and a region where the specific person is present becomes appropriate for recognition, it may be possible to recognize the specific person again depending on the case. However, without such an occasion, it is impossible to recognize the specific person again, and the movable body has to stop moving. In addition, in a case where a plurality of pedestrians are present in the surroundings of the movable body, the specific person may be hidden behind another pedestrian or may move away from the movable body to avoid another pedestrian or an obstacle. For this reason, when failing to recognize the specific person, the movable body is demanded to take an effective action to search for the specific person.

### SUMMARY OF THE INVENTION

The present invention has been made in view of the above problems, and it is an object of the present invention to provide a technique that enables a movable body to take an effective action for searching for a specific person when failing to recognize the specific person.

According to the present invention, a control method of a movable body that moves together with a specific person, the control method comprising: recognizing the specific person and another pedestrian in pedestrians in surroundings of the movable body by using an image obtained by imaging the surroundings of the movable body in a first period; in response to being incapable of recognizing the specific person in an image captured after the first period, predicting a future position of a first candidate with respect to the movable body by using the image captured after the first period, the first candidate being in the pedestrians in the surroundings of the movable body; and controlling traveling of the movable body to move from a current position to a specific position for recognizing the first candidate in accordance with the future position predicted of the first candidate is provided.

Further features of the present invention will become apparent from the following description of exemplary embodiments (with reference to the attached drawings).

### BRIEF DESCRIPTION OF THE DRAWINGS

FIG. 1 is a perspective view illustrating an overall configuration example of a movable body according to the present embodiment;

FIG. 2 is a schematic plan view for describing an example of a travel unit of the movable body according to the present embodiment;

FIG. 3 is a block diagram illustrating an example of a control system of the movable body according to the present embodiment;

FIG. 4 is a block diagram illustrating a functional configuration example of a control unit according to the present embodiment;

FIG. 5A is a diagram (1) for describing processing for searching for a specific person according to the present embodiment;

FIG. 5B is a diagram (2) for describing processing for searching for the specific person according to the present embodiment;

FIG. 5C is a diagram (3) for describing processing for searching for the specific person according to the present embodiment;

FIG. 6 is a flowchart illustrating a series of operations of processing for searching for the specific person according to the present embodiment;

FIG. 7 is a flowchart illustrating a series of operations of pedestrian search processing according to the present embodiment;

FIG. 8 is a flowchart illustrating a series of operations of processing of moving to a viewing position according to the present embodiment; and

FIG. 9 is a diagram for describing an example in which a degree of an open space is defined as a cost according to the present embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Embodiments

In the following embodiments, a case of using a micro mobility vehicle as an example of a movable body will be described as an example. The micro mobility vehicle denotes, for example, a small-sized electric vehicle that is capable of carrying baggage, and that follows, leads, or guides a user (also referred to as a specific person). However, the present embodiment may be applied not only to the case of the vehicle carrying baggage but also to a case of a vehicle where a person can ride, or may be applied to a robot capable of autonomously moving without being limited to vehicles. For example, the present embodiment is also applicable to a robot with no wheels and to be capable of autonomously walking on legs. In addition, in the following description, a movable body including one driven wheel will be described as an example, but the movable body does not necessarily include the driven wheel, and the number of driven wheels is not limited to one, and may be two or more. The present embodiment is applicable not only to a case where the movable body is electrically driven but also to a movable body that moves with other power.

### Configuration of Movable Body

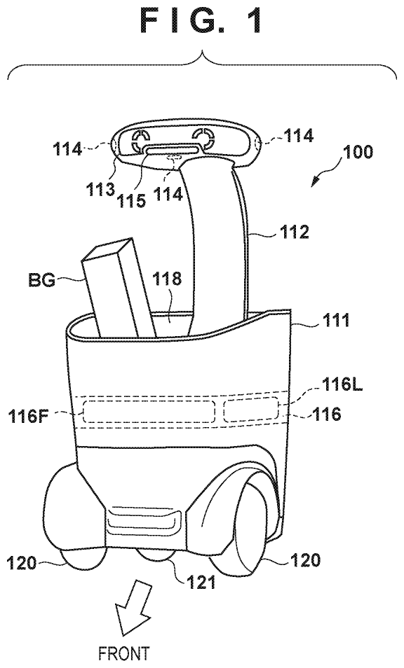

A configuration of a movable body 100 according to an embodiment will be described with reference to FIG. 1. FIG. 1 is a perspective view illustrating an overall configuration of the movable body. As illustrated in FIG. 1, the movable body 100 according to an embodiment includes a lower housing 111, an upper housing 112, a front display unit 113, a plurality of detection units 114, a sound output unit 115, a light emission unit 116, two driving wheels 120, and a driven wheel 121. Note that an end in which the driving wheels 120 are provided will be referred to as the front.

The lower housing 111 holds the driving wheels 120 and the driven wheel 121 to be rotatable, and accommodates a travel unit including the driving wheels 120 and the driven wheel 121. The lower housing 111 includes, in an upper portion, a loading space 118, in which user's baggage can be carried. The lower housing 111 accommodates the light emission unit 116. The region, which accommodates the light emission unit 116, of the lower housing 111 is made of a light-transmissive material.

The upper housing 112 is configured to extend upward from a rear part of the lower housing 111. The upper housing 112 supports, at an upper end portion, the front display unit 113, the detection units 114, and the sound output unit 115.

The front display unit 113 notifies the user of information with an image. The front display unit 113 may be a display device that displays images, such as a liquid crystal display or an organic electroluminescence (EL) display. The front display unit 113 is provided on the front of the upper end of the upper housing 112. The front display unit 113 faces forward. The front display unit 113 notifies the user of information by displaying an image imitating the eyes or the face of a person, characters, and the like.

The plurality of detection units 114 detect target objects such as people and objects in the surroundings of the movable body 100. The detection unit 114 may be an imaging device including an optical system such as a lens, an image sensor, and the like. The detection unit 114 images the surroundings, and outputs image data. The detection unit 114 may include a device capable of detecting an object, such as a radar and a light detection and ranging (LiDAR), instead of or in addition to the imaging device. The plurality of detection units 114 are provided, for example, at the front, back, left, and right of the upper end portion of the upper housing 112. This arrangement enables the plurality of detection units 114 to image all directions (that is, around 360 degrees) of the movable body 100, and to generate an image. Note that the installation position and the number of the detection units 114 are not particularly limited, and may be changed as appropriate.

The sound output unit 115 notifies surrounding people such as a user of information with sound. The sound output unit 115 may be a sound output device such as a speaker.

The light emission unit 116 notifies surrounding people such as the user of information with light. The light emission unit 116 includes, for example, a light emitting element such as one or a plurality of light emitting diodes (LEDs). The light emission unit 116 is provided to surround the lower housing 111. The light emission unit 116 may emit a plurality of colors. The light emission unit 116 is capable of emitting light in different colors depending on the region or direction. That is, for example, the light emission unit 116 emits light in different colors respectively for a front region 116F, a left region 116L, and a right region. In addition, the light emission unit 116 is capable of switching between turning on light and turning off light for every region. Note that with regard to the region, light emission may be controlled in a finer region.

The two driving wheels 120 are provided on the left and right in a front lower portion of the lower housing 111. Driving force is transmitted from the travel unit, and then the driving wheels 120 rotate around the axle.

The driven wheel 121 is provided in a rear portion of the lower housing 111 and at the center of a lower portion. The driven wheel 121 is turnably held around a vertical axis extending in an up-and-down direction.

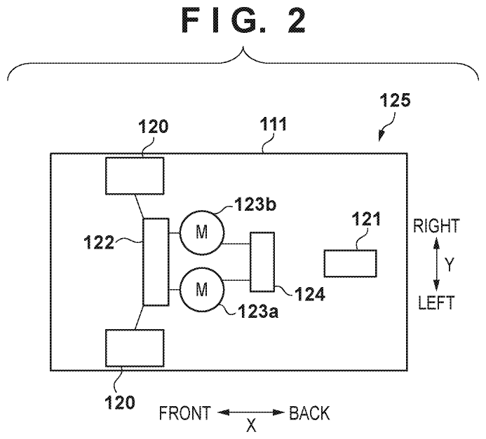

FIG. 2 is a schematic plan view for describing a travel unit 125 of the movable body 100. The travel unit 125 of the movable body 100 will be described with reference to FIG. 2.

The travel unit 125 is provided at a lower part of the lower housing 111. The travel unit 125 includes the two driving wheels 120, the driven wheel 121, a drive mechanism 122, a motor 123a, a motor 123b, and a battery 124.

When electric power is supplied from the battery 124, the motor 123a and the motor 123b function as drive sources, and supply the drive mechanism 122 of the driving force. The drive mechanism 122 transmits the driving force supplied from the motors 123a and 123b to the driving wheels 120. Thus, the drive mechanism 122 rotates the driving wheels 120 to move the movable body 100 forward or backward. The drive mechanism 122 causes a rotation difference between the motor 123a and the motor 123b to set the traveling direction of the movable body 100 to either the left or the right. The drive mechanism 122 changes the magnitude of the rotation difference to achieve various turns of the movable body 100 such as pivotal turn, slow turn, and spin turn.

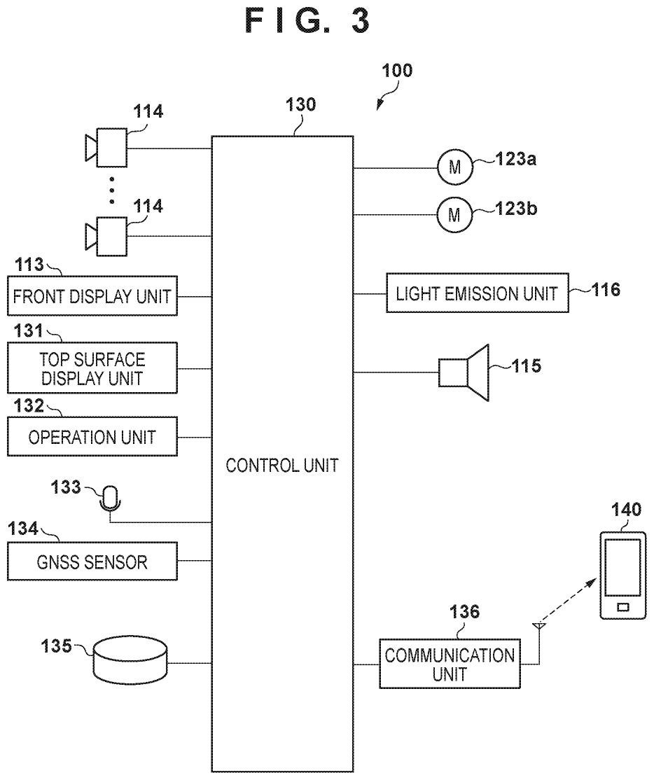

FIG. 3 is a block diagram of a control system of the movable body 100. The control system of the movable body 100 will be described with reference to FIG. 3. As illustrated in FIG. 3, the movable body 100 further includes a control unit 130, an operation unit 132, a top surface display unit 131, a voice input unit 133, a GNSS sensor 134, a storage device 135, and a communication unit 136.

The control unit 130 is an example of a control device, is also called an electronic control unit (ECU), and may be a computer. The control unit 130 conducts overall control of the movable body 100. The control unit 130 includes one or more processors represented by a central processing unit (CPU), a memory device such as a semiconductor memory, an interface with an external device, and the like.

Instead of or in addition to the CPU, the processor may be a micro processing unit (MPU), a graphics processing unit (GPU), a neural processing unit (NPU), a quantum processing unit (QPU), or the like. The processor reads and executes a computer program stored in a memory device or the like, and achieves various functions of the control unit 130.

Some or all of the respective functions of the control unit 130 may be achieved by one or more circuits such as an application specific integrated circuit (ASIC) and a programmable logic device (PLD) including a field programmable gate array (FPGA).

The memory device may be, for example, a random access memory (RAM). The memory device stores a program executed by the processor, data used for processing by the processor, and the like. A plurality of sets of processors, memory devices, and interfaces may be provided for the respective functions of the movable body 100, and each set may be configured to be communicable with each other.

The control unit 130 acquires output such as image information that has been output from the detection unit 114, user input information that has been acquired by the operation unit 132, voice information that has been output by the voice input unit 133, and the like, and performs processing in accordance with each piece of information. The control unit 130 controls the motor 123a and the motor 123b of a travel unit 125 to conduct action control including traveling of the movable body 100. The control unit 130 notifies the user or surrounding people of information. For example, the control unit 130 controls display of images on the front display unit 113 and the top surface display unit 131 to notify the user of information. The control unit 130 may notify the user of information through light emitted by the light emission unit 116. The control unit 130 may notify the user of the information by sound output from the sound output unit 115. The control unit 130 may perform processing using a machine learning model for image recognition (for example, a deep neural network) on image information from the detection units 114. In addition, the control unit 130 may perform processing using the machine learning model for voice recognition (for example, the deep neural network) on voice information from the voice input unit 133.

The control unit 130 is capable of recognizing feature points of an image captured by the detection unit 114 by using the machine learning model. In addition, the control unit 130 is capable of estimating the self-position of the movable body 100 by using the recognized feature points and the map information stored beforehand in the storage device 135. Further, the control unit 130 is capable of recognizing a person (for example, a pedestrian) in the image by using the machine learning model, and assigning a unique identifier (ID) to each pedestrian. Then, the control unit 130 may track the pedestrian, to which the identifier is assigned, in the subsequent images.

The top surface display unit 131 may be a display device capable of displaying an image. The top surface display unit 131 is provided on an upper surface of an upper end of the upper housing 112. The top surface display unit 131 displays images, characters, and the like related to information to be notified to the user, based on the image information acquired from the control unit 130. The top surface display unit 131 displays, for example, an operation screen for receiving an operation from the user.

The operation unit 132 may be an input device such as a touch panel or a keyboard. The operation unit 132 is provided, for example, on the display surface of the top surface display unit 131. The operation unit 132 receives an input from the user, and outputs the input to the control unit 130.

The voice input unit 133 may be a microphone or the like. The voice input unit 133 collects voices of the user and the surroundings of the movable body 100, and outputs the collected voices to the control unit 130.

The GNSS sensor 134 receives a GNSS signal from a satellite, and detects the current position of the movable body 100. Note that GNSS is an abbreviation for global navigation satellite system.

The storage device 135 includes a nonvolatile memory medium that stores various types of data. The storage device 135 may be a hard disk drive (HDD), a solid state drive (SSD), or the like. The storage device 135 may store a program to be executed by the processor, parameters necessary for executing the program, data to be processed by the processor, and the like. The storage device 135 may store various parameters of the machine learning models (for example, learned parameters of the deep neural network, hyperparameters, and the like) for sound recognition or image recognition to be performed by the control unit 130. The storage device 135 is capable of storing map information of a space where the movable body 100 travels. The map information denotes map information given beforehand, and the map information may be partially changed (updated) while the movable body 100 is traveling. The map information may be represented, for example, in the form of an occupancy grid map, and each grid can represent a region where the movable body 100 is capable of traveling or a region of an obstacle. In a case where the current position of the movable body 100 is arranged at the center of the occupancy grid map, the position of the obstacle viewed from the current position of the movable body 100 can be identified.

The communication unit 136 communicates with an external device such as a communication terminal 140 of the user on wireless communication such as Wi-Fi and the fifth generation mobile communication.

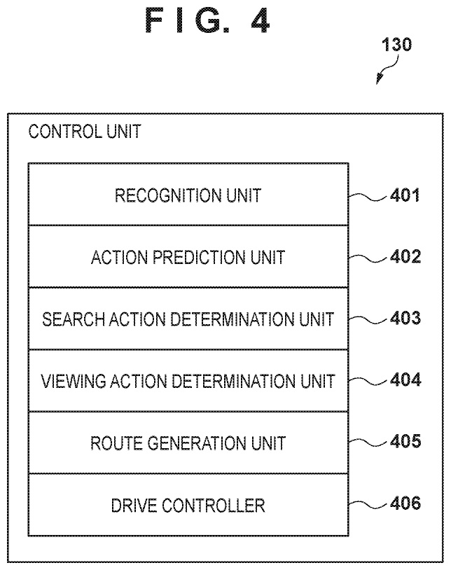

FIG. 4 is a functional block diagram illustrating functions of the control unit 130. The functions of the control unit 130 will be described with reference to FIG. 4.

The control unit 130 includes a recognition unit 401, an action prediction unit 402, a search action determination unit 403, a viewing action determination unit 404, a route generation unit 405, and a drive controller 406. For example, by reading a program from the storage device 135 and executing the program, the control unit 130 may enable the functions of the respective units of the control unit 130.

The recognition unit 401 recognizes feature amounts of surrounding environment of the movable body 100 from the image captured by the detection unit 114 imaging the surroundings of the movable body 100. The recognition unit 401 may recognize the feature amounts of the surrounding environment from a plurality of images obtained by imaging various directions of the movable body 100 by using one or more learned machine learning models. The feature amounts of the surrounding environment include feature amounts in an image that can be associated with, for example, a road, a passage, a building, a wall, a store, a signboard, a sign, an obstacle, a pedestrian, a vehicle, and the like.

In addition, the recognition unit 401 recognizes a pedestrian in the surroundings of the movable body 100 from an image captured by the detection unit 114 imaging the surroundings of the movable body 100. In a case where the face or the entire body of the user (a specific person) is imaged and the feature amount of the user is registered beforehand, the recognition unit 401 is capable of recognizing a pedestrian in the image captured by the detection unit 114 by using the machine learning model, and recognizing the specific person and the other pedestrians. Furthermore, the recognition unit 401 assigns a unique identifier to each recognized specific person and each of the other pedestrians, and tracks the specific person and each pedestrian in an image in the subsequent images. As a result of recognizing the pedestrians in the image, in a case where a new pedestrian (a pedestrian whose feature does not match that of the pedestrian to which the identifier has already been assigned) appears, the recognition unit 401 assigns a new identifier to such a pedestrian.

The action prediction unit 402 predicts a future position of each pedestrian with respect to the movable body 100 by using the image captured by the detection unit 114. It is possible to use a known technique for the technique of predicting the future position of the pedestrian using the image. For example, the action prediction unit 402 outputs information indicating that a pedestrian A will be located at a position (x, y) on a plane on which the movable body 100 travels (with the position of the movable body 100 as the origin), if a time Δt elapses from the current time.

The search action determination unit 403 determines an action of searching for the specific person to recognize the specific person again in response to being incapable of recognizing the specific person. The search action determination unit 403 selects a candidate to be searched for from the pedestrians who have been recognized in the image, and determines an action of moving from the current position to a specific position for recognizing the candidate (for example, a position from which it becomes possible to image the entire body of the candidate with a predetermined size or more). In addition, when the specific person is not included in the pedestrians in the surroundings of the movable body 100, the search action determination unit 403 determines an action of moving to a hidden region to be hidden from the movable body 100, and searching for the specific person. The hidden region is, for example, a region to be a blind spot from the movable body due to existence of an obstacle. Details of processing by the search action determination unit 403 will be described later.

When determining that the specific person is not present also after taking the action determined by the search action determination unit 403, the viewing action determination unit 404 determines an action toward a predetermined place (a viewing position) appropriate for finding the specific person. Then, the viewing action determination unit 404 recognizes the specific person by using an image captured at such a predetermined place. It can be said that such a viewing position denotes a position from which it is visually easy for the specific person to recognize the movable body 100. Details of processing by the viewing action determination unit 404 will be described later.

The route generation unit 405 generates a route on which the movable body 100 travels. In a case where the user is present in a travel region, the route generation unit 405 generates a route for following or leading the user. The route generation unit 405 also generates a route for the action determined by the search action determination unit 403 or the viewing action determination unit 404.

The drive controller 406 controls, for example, the motor 123a and the motor 123b, and causes the movable body 100 to travel along the route that has been generated by the route generation unit 405. The drive controller 406 may rotate the motor 123a and the motor 123b in reverse directions to each other to make the spin turn or the pivotal turn (also referred to as turn on the spot) without moving the movable body 100. Note that the drive controller 406 may turn the movable body 100 other than the spin turn.

### Outline of Processing for Searching for Specific Person

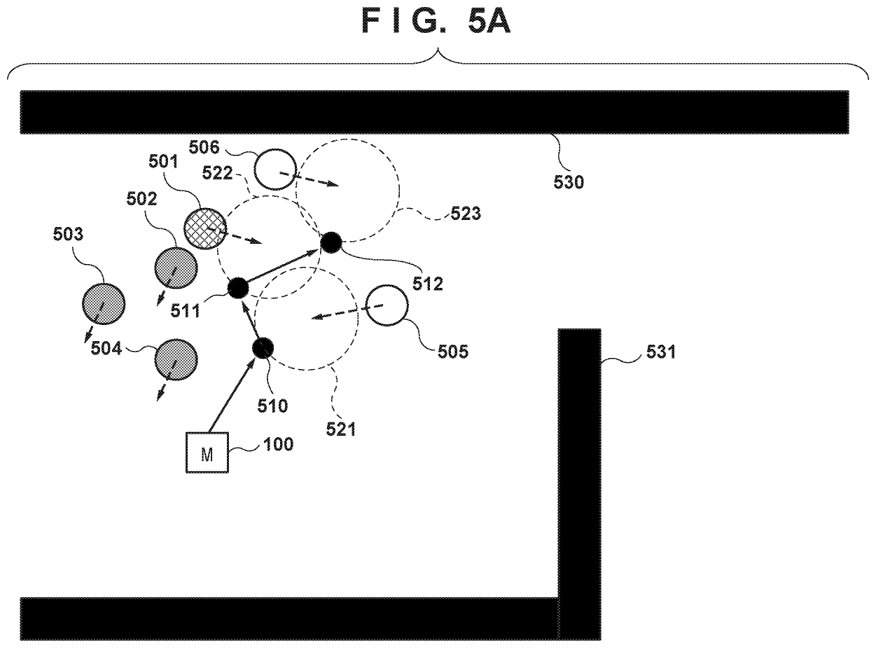

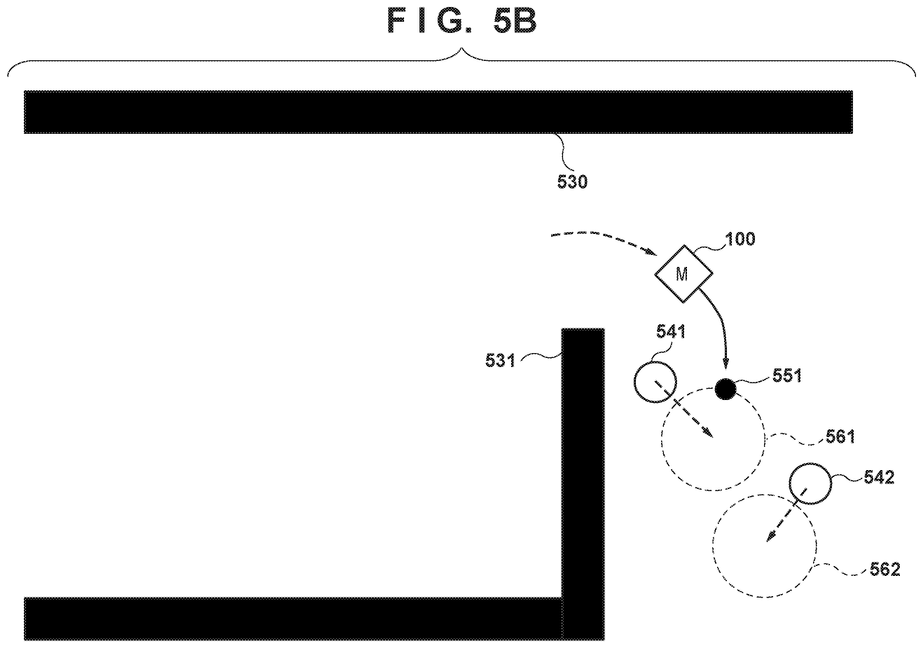

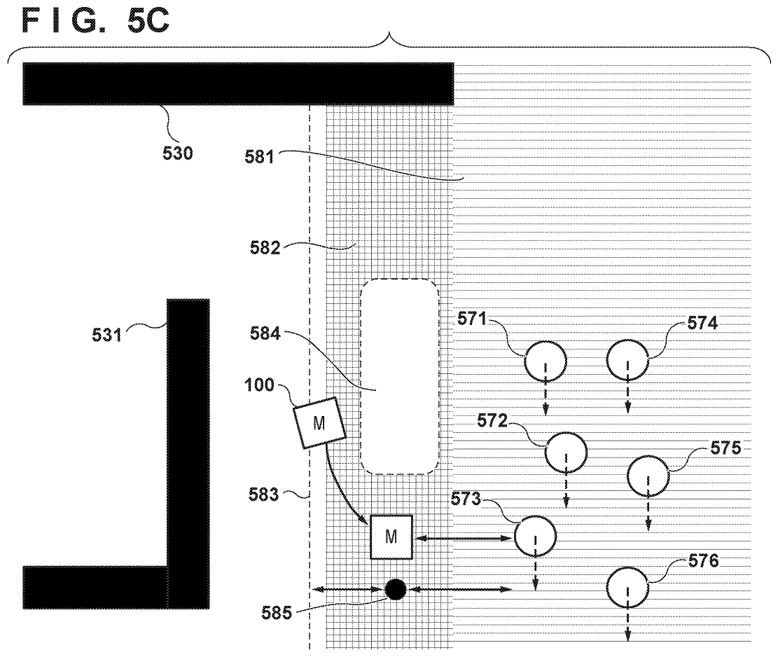

Next, an outline of processing for searching for a specific person according to the present embodiment will be described with reference to FIGS. 5A to 5C. FIG. 5A schematically illustrates a state in which the movable body 100, a pedestrian, and an obstacle are present on a plane on which the movable body 100 travels. Pedestrians 501 to 506 are respectively moving in the surroundings of the movable body 100, and a wall 530 and a wall 531 are present in the surroundings of the movable body 100 and the pedestrians 501 to 506. It is assumed that the pedestrian 501 has been recognized and tracked as the specific person in an image that has been captured before (for example, in a first period). However, at a timing illustrated in FIG. 5A, it becomes impossible for the control unit 130 to recognize the specific person (because, for example, the specific person is partially hidden behind the pedestrian 502). For this reason, the control unit 130 recognizes the pedestrian 501 as a new pedestrian. The pedestrians 502 to 504 have been recognized and tracked (the unique identifier has been assigned to each one) in a former image (in the first period). The pedestrian 505 and the pedestrian 506 are pedestrians who were recognized after the control unit 130 had not been capable of recognizing the specific person.

The control unit 130 predicts a future position of each pedestrian with respect to the movable body 100. Note that in FIG. 5A, an arrow extending from each pedestrian indicates a vector toward a future position (a position after the time Δt) that has been predicted from the current position of the pedestrian. A circle 521, which surrounds the future position of the pedestrian 505, represents a specific position for the movable body 100 to recognize the pedestrian 505. A circle 521 represents, for example, a distance of three meters from the pedestrian 505. Similarly, a circle 522, which surrounds the future position of the pedestrian 501, indicates a specific position for the movable body 100 to recognize the pedestrian 501. Furthermore, a circle 523, which surrounds the future position of the pedestrian 506, indicates a specific position for the movable body 100 to recognize the pedestrian 506.

The control unit 130 selects a candidate for the specific person. For example, the control unit 130 excludes pedestrians (the pedestrians 502 to 504) who have been recognized to be distinguished from the specific person in the image captured in the first period from the pedestrians (the pedestrians 501 to 506) included in the image captured after the first period. Then, the control unit 130 selects the candidate for the specific person from the remaining pedestrians. This is because the pedestrians 502 to 504 were distinguished from the specific person and tracked in the image captured before, and thus it can be determined that these pedestrians are not the specific person.

For example, the control unit 130 is capable of selecting, as a first candidate, a pedestrian (in this case, the pedestrian 505), who is located to be closest to the movable body 100, from the predicted future positions. After moving to a specific position (for example, a position 510 on the circle 521) in accordance with the predicted future position of the first candidate, the control unit 130 recognizes the specific person by using the image including the first candidate. This makes it possible to efficiently search for a pedestrian who has a high possibility of being the specific person.

For example, the position 510 denotes a position from which more parts (for example, the face, both shoulders, both arms, the waist, both feet, and the like) of the entire body of the first candidate are recognizable in the image than those from the current position of the movable body 100. When more parts of the entire body of the pedestrian are recognizable, it becomes possible to accurately compare the feature amount of the registered specific person with the feature amount of the pedestrian in the image. In other words, in this example, in recognizing, for example, a key point of the first candidate in the image, the position 510 is higher in recognition accuracy of the key point of the first candidate than the current position of the movable body 100. In a case where the recognition accuracy of the key point of the pedestrian is high, it becomes possible to accurately compare the feature amount of the registered specific person with the feature amount of the pedestrian in the image.

When determining that the specific person is not present by using the image including the first candidate, the control unit 130 sets, as a second candidate, a pedestrian (in this case, 501) whose predicted future position is the second closest to the movable body 100. After moving to a specific position (for example, a position 511 on the circle 522) for recognizing the second candidate in accordance with the predicted future position of the second candidate, the control unit 130 recognizes the specific person by using the image including the second candidate. In the example illustrated in FIG. 5A, since the pedestrian 501 is the specific person, the control unit 130 is capable of recognizing the specific person by using the image captured at the position 511.

The control unit 130 may estimate a route for sequentially moving through the predicted future positions, and may select the first pedestrian in moving along the route, as the first candidate. In the example illustrated in FIG. 5A, the control unit 130 estimates a route for sequentially moving through the position 510, the position 511, and a position 512. When moving on this route, the first pedestrian is the pedestrian 505 in moving along the route, and the control unit 130 is capable of selecting the pedestrian 505 as the first candidate.

When determining that the specific person is not present by using the image including the first candidate, the movable body 100 is capable of moving to the hidden region to be hidden from the movable body 100, based on the occupancy grid map indicating the positions of the obstacles in the surroundings. For example, the wall 531 is indicated as an obstacle in the occupancy grid map. In addition, the opposite side of the wall 531 when viewed from the movable body 100 illustrated in FIG. 5A is the hidden region (for example, a travelable region that is a blind spot from the movable body 100 due to existence of an obstacle).

Note that the movable body 100 may output a sound or a display indicating that the movable body 100 is searching for the specific person in response to being incapable of recognizing the specific person in the captured image. The sound or the display may be, for example, a speech or a display including the name of the specific person, or may be a speech or a display simply indicating while in searching for the specific person. In this manner, the movable body 100 will be easily found by the specific person.

FIG. 5B illustrates an example in which the movable body 100 travels in the hidden region of the wall 531 to search for the user. The movable body 100 identifies a hidden region, based on the above-described occupancy grid map, and moves to the hidden region. The movable body 100 recognizes the specific person by using the image captured after having moved to the hidden region. The movable body 100 predicts the future positions of a pedestrian 541 and a pedestrian 542 by using an image captured while traveling in the hidden region. The movable body 100 selects, for example, the pedestrian 541 as a third candidate, and moves to a specific position for recognizing the third candidate (a position 551 on a circle 561). The movable body 100 determines whether the specific person is present by using the image including the pedestrian 541 and captured at the position 551. When determining that the specific person is not present, the movable body 100 moves to a specific position for recognizing the pedestrian 542 (a position on a circle 562), and then recognizes the pedestrian 542.

As illustrated in FIG. 5C, when determining that the specific person is not present by using the image captured after having moved to the hidden region, the movable body 100 may travel to a predetermined position (a viewing position) appropriate for finding the specific person. In this case, the movable body 100 recognizes the specific person by using an image captured at the predetermined position.

Note that in the above-described embodiment, the case where the movable body 100 moves to the hidden region, and then travels to the predetermined position has been described as an example. However, after the action illustrated in FIG. 5A, the movable body 100 may travel to the predetermined position.

FIG. 5C illustrates an example in which the movable body 100 determines a viewing position, and recognizes the specific person from a flow of people. In the example illustrated in FIG. 5C, pedestrians 571 to 576 are moving while forming the flow of people. A region 581 indicates a region where the distance to a pedestrian forming the flow of people is short and it is impossible to include the whole body of the pedestrian within the angle of view. From a region 582, which is adjacent to the region 581, it is possible to include substantially the entire body of the pedestrian forming the flow of people within the angle of view. In this region, the density of pedestrians is equal to or smaller than a predetermined threshold. On the other hand, when being apart from the position of the flow of people to a line 583, the recognition accuracy of the pedestrian by using the image decreases. In other words, the viewing position is a position equal to or lower in the density of pedestrians than the predetermined threshold, and includes a position from which it is possible to image a region higher in the density of the pedestrians than such a position.

A region 584 indicates a region where a shadow is formed by the position of the sun, the position of a building, and the like, and the illuminance is lower than surrounding regions. Note that without being limited to this example, the region 584 may be, for example, a region to be included in backlight by the position of the sun, the position of a building, and the like, when the direction of the flow of people is imaged from the region 584.

The movable body 100 is capable of obtaining the viewing position by using superimposition of costs. For example, the movable body 100 is capable of using a first cost in accordance with the distance from the pedestrian. This cost increases as getting closer to the pedestrian from a boundary A between the region 581 and the region 582. On the other hand, in a straight line from the boundary A toward the line 583, the cost decreases toward the position (a position 585) of the center of the region 582, and increases toward the line 583 from the position 585. That is, in imaging from the direction perpendicular to the direction of the flow of people, the cost of the position from which it is possible to image the substantially entire body of the pedestrian is set to decrease. When the position is too close to the pedestrian or too far from the pedestrian, the cost is set to increase.

In addition, the movable body 100 is capable of using a cost in accordance with brightness. For example, it is possible to set the cost in the region 584 to be higher than those in the other regions. In this case, the movable body 100 is controlled not to image the flow of people from the region 584.

Furthermore, the movable body 100 is capable of using a cost in accordance with the density of the pedestrians in a captured image. For example, in a region where the flow of people is present in the region 581, the density of the pedestrians is high, and the cost increases, but the cost decreases in the other regions.

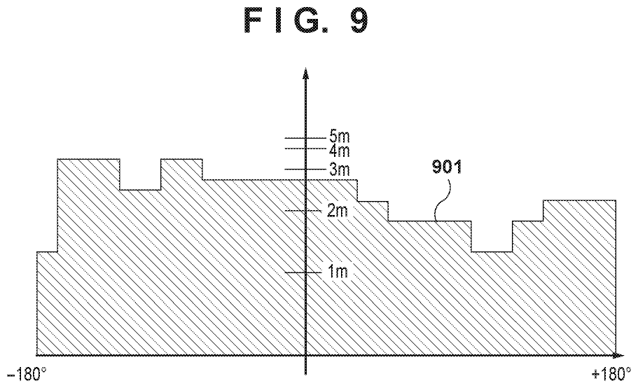

The movable body 100 may use a cost in accordance with a degree of the open space. The degree of the open space may be calculated from a graph illustrated in FIG. 9, for example. The graph illustrated in FIG. 9 is obtained by adding up the distances from a certain grid (position) to a grid of an obstacle in the respective directions from such a certain grid in the occupancy grid map. This indicates that the space is present when the obstacle is far from the certain grid at all angles. That is, the area of a region 901 represents the degree of the open space, and indicates that as the area increases, a larger space is present. Here, the vertical axis in FIG. 9 is set in such a manner that as the distance from the grid to the obstacle increases, the scale decreases. In this manner, the area of the region 901 becomes wider, as no obstacle is present (the space is present) at a position closer to the grid. That is, it is possible to configure the cost so that the absence of an obstacle in the vicinity is more important than the absence of an obstacle in the distance. In the example illustrated in FIG. 5C, for example, the cost increases at a position closer to the wall 530 or the wall 531, whereas the cost decreases at a position farther from these obstacles.

The movable body 100 is capable of obtaining the viewing position by using the above-described superimposition of the costs. For example, it is sufficient for the movable body 100 to set, as the viewing position, a position having the lowest one of the superimposed costs, and to generate a route to the viewing position. For example, the cost is high around the wall 530 in the region 582 and in the region 584. Therefore, for example, the movable body 100 is capable of setting a position below the region 582 in the region 584 as the viewing position.

When arriving at the viewing position and starting to image the flow of people, the movable body 100 may output a sound or a display indicating that the movable body 100 is searching for the specific person. The sound or the display may be, for example, a speech or a display including the name of the specific person, or may be a speech or a display simply indicating while in searching for the specific person.

### Series of Operations of Processing for Searching for Specific Person

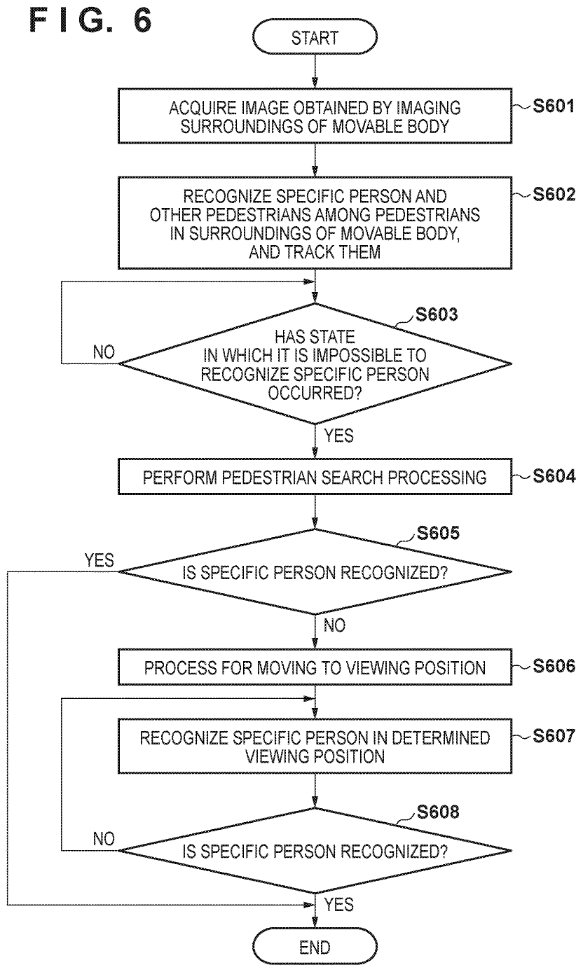

A series of operations of processing for searching for the specific person performed by the control unit 130 will be described with reference to FIG. 6. Note that this series of operations is enabled by the control unit 130 executing a program stored in the storage device 135 and the respective units in the control unit 130 performing the processing. In addition, this series of operations can be performed while the movable body 100 is autonomously traveling.

In S601, the recognition unit 401 acquires an image obtained by imaging the surroundings of the movable body 100 in the first period from the detection unit 114. In S602, the recognition unit 401 recognizes the specific person and the other pedestrians in the pedestrians in the surroundings of the movable body 100 by using the image captured in the first period, and tracks them in the image. As described above, the recognition unit 401 is capable of recognizing pedestrians in the image captured by the detection unit 114 by using the machine learning model, and is capable of recognizing the specific person and the other pedestrians. In addition, the recognition unit 401 assigns an identifier to each the specific person and the other pedestrians, and tracks them in the image.

In S603, the recognition unit 401 further acquires an image captured after the first period, and then determines whether a state in which it is impossible to recognize the specific person in the image has occurred. In a case where it is impossible to recognize the specific person in the image, the recognition unit 401 advances the processing to S604. In the other case, the recognition unit 401 repeats the processing of S603.

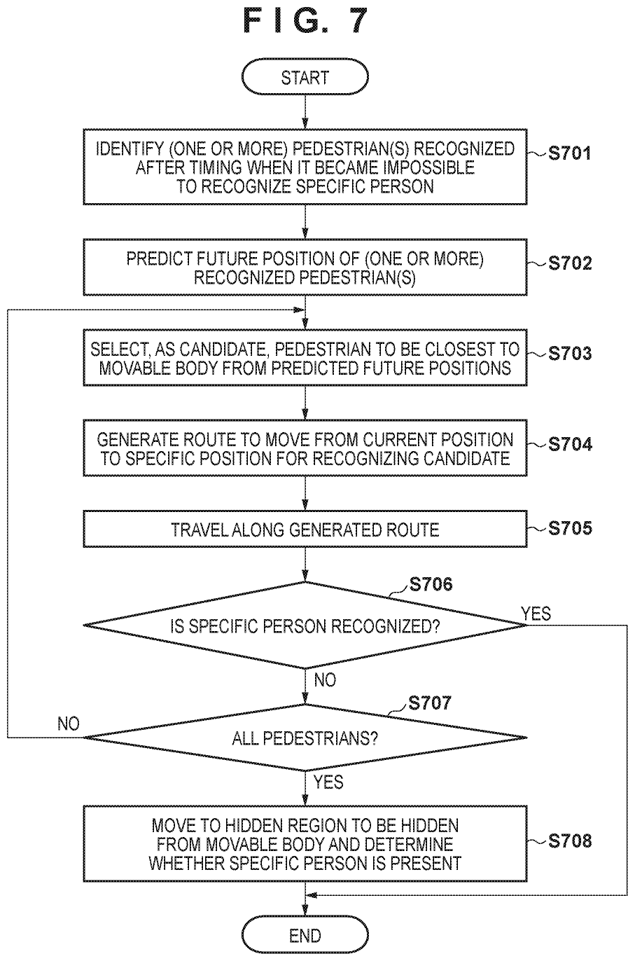

In S604, the search action determination unit 403 performs pedestrian search processing (processing of searching for the specific person to recognize the specific person again). Details of this processing will be described later with reference to FIG. 7.

In S605, the recognition unit 401 further acquires a captured image, and determines whether the specific person is recognized in the image. In a case where the recognition unit 401 determines that the specific person is not recognized in the image, the processing proceeds to S606. In the other case, the processing ends.

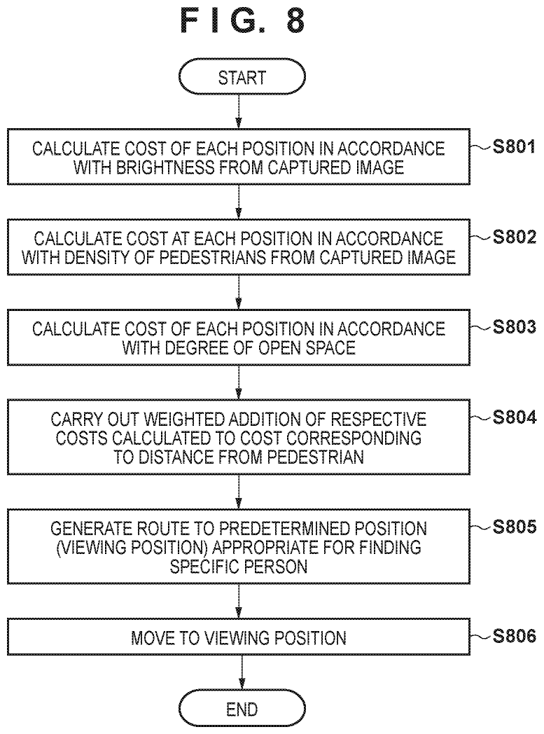

In S606, the viewing action determination unit 404 performs processing of moving to the viewing position. Details of this processing will be described later with reference to FIG. 8. In step S607, the recognition unit 401 further acquires an image captured at the viewing position, and performs processing of recognizing the specific person in the image. In S608, the recognition unit 401 determines whether the specific person is recognized in the image captured at the viewing position. In a case where the recognition unit 401 determines that the specific person is not recognized, the processing proceeds to S606. In the other case, the processing ends.

### Series of Operations of Pedestrian Search Processing

A series of operations of the pedestrian search processing performed by the control unit 130 will be described with reference to FIG. 7. Note that the series of operations of the pedestrian search processing is enabled by the control unit 130 executing a program stored in the storage device 135 and the respective units in the control unit 130 performing the processing. This processing is started when the processing of S604 is performed.

In S701, the search action determination unit 403 identifies (one or more) pedestrian(s) recognized after the timing when it became impossible to recognize the specific person. As described above, the search action determination unit 403 identifies the pedestrian 501, the pedestrian 505, and the pedestrian 506 who have been recognized after it became impossible to recognize the specific person in the pedestrians illustrated in FIG. 5A.

In S702, the action prediction unit 402 predicts the future position of the (one or more) recognized pedestrian(s). As described above, for example, the action prediction unit 402 predicts the respective future positions of the pedestrian 501, the pedestrian 505, and the pedestrian 506 with respect to the movable body 100.

In S703, the search action determination unit 403 selects, as a candidate, a pedestrian to be closest to the movable body 100 from the predicted future positions. In the above-described example, for example, the search action determination unit 403 selects, as the candidate, the pedestrian (the pedestrian 505) who is to be closest to the movable body 100 from the predicted future positions.

In S704, the search action determination unit 403 determines a specific position for recognizing the candidate, and the route generation unit 405 generates a route to move from the current position to the specific position. In S705, the drive controller 406 controls the movable body 100 to travel along the generated route to the specific position for recognizing the candidate.

In S706, the recognition unit 401 determines whether the specific person is recognized by using the image captured at the specific position for recognizing the candidate. In a case where the recognition unit 401 determines that the specific person is recognized, the processing returns to S604 in the main processing. In the other case, the processing proceeds to S707.

In the example illustrated in FIG. 5A, the pedestrian 501 is the pedestrian who cannot be recognized as the specific person. Therefore, in a case where the processing is sequentially performed for the pedestrians identified in S701, and when the pedestrian 501 is recognized by using the image captured at the position 511 (the specific position for recognizing the pedestrian 501), the recognition unit 401 determines that the specific person is recognized.

In S707, the search action determination unit 403 determines whether the processing has been performed for all the pedestrians (the pedestrian 501, the pedestrian 505, and the pedestrian 506) identified in S701. In a case where the search action determination unit 403 has performed the processing for all the pedestrians, the processing proceeds to S708. In the other case, the processing returns to S703.

Note that in the present embodiment, a case where the processing is repeated for all the pedestrians identified in S701 is described as an example. However, the present embodiment is not limited to this example. The search action determination unit 403 may advance the processing to S708 in a case where the route for moving to recognize each pedestrian (in the example of FIG. 5A, the route to the position 512 through the position 510 and the position 511) exceeds a predetermined length.

In S708, the search action determination unit 403 moves to a hidden region to be hidden from the movable body 100, based on the occupancy grid map indicating the positions of surrounding obstacles. As described above, the search action determination unit 403 moves to the travelable region that is a blind spot from the movable body 100, for example, due to existence of an obstacle. Then, the recognition unit 401 recognizes the specific person (determines whether the specific person is present in the image) by using the image captured in the hidden region. The search action determination unit 403 may perform processing similar to those in S702 to S706 for the pedestrian who is present in the hidden region. Upon completion of the processing of S708, the search action determination unit 403 returns the processing to S604 in the main processing.

### Series of Operations of Processing of Moving to Viewing Position

A series of operations of processing of moving to the viewing position performed by the control unit 130 will be described with reference to FIG. 8. Note that the series of operations of processing of moving to the viewing position is enabled by the control unit 130 executing a program stored in the storage device 135 and the respective units in the control unit 130 performing the processing. This processing is started when the processing of S606 is performed.

In S801, for example, the viewing action determination unit 404 calculates the cost of each position (in the surroundings of the movable body 100) in accordance with the brightness from the captured image. In the above-described example with reference to FIG. 5C, for example, the cost may be higher at a darker position (for example, the region 584), and the cost may be lower at a brighter position (for example, any region other than the region 584).

In S802, for example, the viewing action determination unit 404 calculates the cost at each position in accordance with the density of pedestrians from the captured image. In the above-described example with reference to FIG. 5C, for example, the density of pedestrians is high at a position where there is the flow of people in the region 581, and thus the cost increases, whereas the cost decreases at the other positions.

In S803, the viewing action determination unit 404 calculates the cost of each position in accordance with the degree of the open space. In the example illustrated in FIG. 5C, the cost is higher at a position closer to the wall 531, and the cost is lower at a position farther from the wall 531.

In S804, the viewing action determination unit 404 carries out weighted addition of the respective costs calculated in S801 to S803 to the cost corresponding to the distance from the pedestrian. In S805, the viewing action determination unit 404 generates a route to the viewing position. For example, the viewing action determination unit 404 sets a position where the cost is the lowest one of the superimposed costs as the viewing position, and generates a route to the viewing position. In S806, the drive controller 406 controls the movable body 100 to travel in accordance with the route to the viewing position. Upon completion of the processing of S806, the viewing action determination unit 404 returns the processing to S606 in the main processing.

Note that in the above-described embodiment, all the costs calculated in S801 to S803 are used. However, the second cost of at least one of the cost in accordance with the brightness, the cost in accordance with the density of pedestrians in the captured image, and the cost in accordance with the degree of the open space may be used for the weighted addition to the first cost in accordance with the distance from the pedestrian.

Note that in the above-described embodiment, the case where the control device is the control unit 130 of the movable body 100 has been described as an example. However, the control device may be included in, for example, an information processing server present outside the movable body 100. In this case, the control device may perform a part or the entirety of the processing performed by the above-described control unit 130 while communicating with the movable body 100. That is, the present embodiment is also applicable to a case where the movable body 100 is remotely controlled from another apparatus separate from the movable body 100.

As described heretofore, in the above-described embodiment, the control unit 130 recognizes the specific person and the other pedestrians (the pedestrians 501 to 504) in the pedestrians in the surroundings of the movable body 100, by using an image obtained by imaging the surroundings of the movable body 100 in the first period. In response to being incapable of recognizing the specific person in the image captured after the first period, the control unit 130 predicts the future position of the first candidate (for example, the pedestrian 505) in the pedestrians in the surroundings of the movable body 100 with respect to the movable body 100, by using the image captured after the first period. In addition, the control unit 130 controls the movable body 100 to travel and move from the current position to a specific position (for example, the position 510) for recognizing the first candidate in accordance with the predicted future position of the first candidate. In this manner, when failing to recognize the specific person, the movable body is capable of taking an effective action to search for the specific person.

Furthermore, in the present embodiment, the control unit 130 identifies the hidden region, based on the occupancy grid map, moves the movable body 100 to the hidden region, and recognizes the specific person by using the image captured in the hidden region. In addition, the control unit 130 determines the viewing position using superimposition of costs, and recognizes the specific person by using the image captured from the viewing position. By further combining these types of action control, when failing to recognize the specific person, the movable body is capable of taking an effective action to search for the specific person.

### Summary of Embodiments

### Configuration 1

A control method of a movable body that moves together with a specific person, the control method comprising:
recognizing the specific person and another pedestrian in pedestrians in surroundings of the movable body by using an image obtained by imaging the surroundings of the movable body in a first period;
in response to being incapable of recognizing the specific person in an image captured after the first period,
   predicting a future position of a first candidate with respect to the movable body by using the image captured after the first period, the first candidate being in the pedestrians in the surroundings of the movable body; and
   controlling traveling of the movable body to move from a current position to a specific position for recognizing the first candidate in accordance with the future position predicted of the first candidate

In this embodiment, when failing to recognize the specific person, the movable body is capable of taking an effective action to search for the specific person.

### Configuration 2

The control method according to configuration 1, wherein more parts of an entire body of the first candidate are recognizable from the image from the specific position than from the current position.

In this embodiment, as long as more parts of the entire body of the pedestrian are recognizable, it becomes possible to accurately compare the feature amount of the registered specific person with the feature amount of the pedestrian in the image.

### Configuration 3

The control method according to configuration 1, wherein in recognizing a key point of the first candidate from the image, the key point of the first candidate is higher at the specific position in recognition accuracy than at the current position.

In this embodiment, in a case where the accuracy of recognizing the key point of the pedestrian is high, it becomes possible to accurately compare the feature amount of the registered specific person with the feature amount of the pedestrian in the image.

### Configuration 4

The control method according to configuration 1, wherein the predicting the future position of the first candidate with respect to the movable body includes:
predicting a future position of a pedestrian in the surroundings of the movable body with respect to the movable body by using the image captured after the first period; and
selecting, as the first candidate, a pedestrian closest to the movable body from the future position predicted.

In this embodiment, it becomes possible to efficiently search for a pedestrian who has a high possibility of being the specific person.

### Configuration 5

The control method according to configuration 1, wherein the predicting the future position of the first candidate with respect to the movable body includes:
predicting a future position of a pedestrian in the surroundings of the movable body with respect to the movable body by using the image captured after the first period; and
estimating a route for sequentially moving through the future position predicted, and selecting a first pedestrian in moving the route as the first candidate.

In this embodiment, it becomes possible to optimize the search for the pedestrian who has a high possibility of being the specific person.

### Configuration 6

The control method according to configuration 1, wherein the predicting the future position of the first candidate with respect to the movable body includes:
removing the another pedestrian recognized to be distinguished from the specific person in the image captured in the first period from the pedestrians included in the image captured after the first period; and
selecting the first candidate from a remaining pedestrian who remains after the another pedestrian is excluded.

In this embodiment, it becomes possible to reduce the operation cost for searching for the specific person, by excluding a pedestrian who has a high possibility of not being the specific person from the search range.

### Configuration 7

The control method according to configuration 1, wherein the predicting the future position of the first candidate with respect to the movable body includes:
removing the another pedestrian recognized to be distinguished from the specific person in the image captured in the first period from the pedestrians included in the image captured after the first period; and
predicting a future position of a remaining pedestrian with respect to the movable body, the remaining pedestrian remaining after the another pedestrian is excluded; and
selecting, as the first candidate, a pedestrian closest to the movable body from the future position predicted.

In this embodiment, it becomes possible to reduce the operation cost for predicting the future position of the pedestrian, by excluding the pedestrian who has a high possibility of not being the specific person from the search range.

### Configuration 8

The control method according to configuration 1, further comprising after moving to the specific position in accordance with the future position predicted of the first candidate, recognizing the specific person by using an image including the first candidate.

In this embodiment, the movable body is capable of taking an effective action to search for the specific person.

### Configuration 9

The control method according to configuration 1, wherein after moving to the specific position in accordance with the future position predicted of the first candidate, when determining that the specific person is absent by using an image including the first candidate,
predicting a future position of a second candidate with respect to the movable body by using the image captured after the first period, the second candidate being in the pedestrians in the surroundings of the movable body; and
controlling the traveling of the movable body to move to a specific position for recognizing the second candidate in accordance with the future position predicted of the second candidate.

In this embodiment, it becomes possible to sequentially search for the pedestrian who has a high possibility of being the specific person.

### Configuration 10

The control method according to configuration 1, wherein after moving to the specific position in accordance with the future position predicted of the first candidate, when determining that the specific person is absent by using an image including the first candidate,
moving to a hidden region to be hidden from the movable body, based on an occupancy grid map indicating a position of an obstacle in the surroundings of the movable body; and
recognizing the specific person by using an image captured after moving to the hidden region.

In this embodiment, the search range can be expanded from the surroundings of the movable body to another region where there is a possibility that the specific person is present.

### Configuration 11

The control method according to configuration 1, wherein after moving to the specific position in accordance with the future position predicted of the first candidate, when determining that the specific person is absent by using an image including the first candidate,
traveling to a predetermined position for finding the specific person; and
recognizing the specific person by using an image captured at the predetermined position.

In this embodiment, in a case where it is impossible to find the specific person in the surroundings of the movable body, it becomes possible to search for the specific person from a viewing position appropriate for finding the specific person.

### Configuration 12

The control method according to configuration 11, wherein the predetermined position for finding the specific person is equal to or lower in density of the pedestrians than a predetermined threshold, and imaging of a region higher in the density of the pedestrians than the predetermined position is enabled at the predetermined position.

In this embodiment, it becomes possible to search for the specific person in the flow of people from a position apart from the flow of people.

### Configuration 13

The control method according to configuration 10, wherein after moving to the hidden region, when determining that the specific person is absent by using an image captured after moving to the hidden region,
traveling to a predetermined position for finding the specific person; and
recognizing the specific person by using an image captured at the predetermined position.

In this embodiment, after the search range is expanded to a region where there is a possibility that the specific person is present, it becomes possible to search for the specific person from the viewing position appropriate for finding the specific person.

### Configuration 14

The control method according to configuration 11, further comprising determining the predetermined position for finding the specific person by using a cost obtained by carrying out weighted addition of a second cost to a first cost of each position in the surroundings of the movable body in accordance with a distance from a pedestrian, the second cost including at least one of: a cost of each position in the surroundings of the movable body in accordance with brightness; a cost of each position in the surroundings of the movable body in accordance with density of pedestrians in a captured image; and a cost of each position in the surroundings of the movable body in accordance with a degree of an open space.

In this embodiment, it becomes possible to move the movable body to a meaningful position for finding the specific person.

### Configuration 15

The control method according to configuration 1, further comprising outputting a sound or a display indicating that the specific person is being searched for in response to being incapable of recognizing the specific person in the image captured after the first period.

In this embodiment, the movable body will be easily found from the specific person.

The invention is not limited to the foregoing embodiments, and various variations/changes are possible within the spirit of the invention.

What is claimed is:

1. A control method of a movable body that moves together with a specific person, the control method comprising:
recognizing the specific person and another pedestrian in pedestrians in surroundings of the movable body by using an image obtained by imaging the surroundings of the movable body in a first period;
in response to being incapable of recognizing the specific person in an image captured after the first period,
predicting a future position of a first candidate with respect to the movable body by using the image captured after the first period, the first candidate being in the pedestrians in the surroundings of the movable body; and
controlling traveling of the movable body to move from a current position to a specific position for recognizing the first candidate in accordance with the future position predicted of the first candidate.

2. The control method according to claim 1, wherein more parts of an entire body of the first candidate are recognizable from the image from the specific position than from the current position.

3. The control method according to claim 1, wherein in recognizing a key point of the first candidate from the image, the key point of the first candidate is higher at the specific position in recognition accuracy than at the current position.

4. The control method according to claim 1, wherein the predicting the future position of the first candidate with respect to the movable body includes:
predicting a future position of a pedestrian in the surroundings of the movable body with respect to the movable body by using the image captured after the first period; and
selecting, as the first candidate, a pedestrian closest to the movable body from the future position predicted.

5. The control method according to claim 1, wherein the predicting the future position of the first candidate with respect to the movable body includes:
predicting a future position of a pedestrian in the surroundings of the movable body with respect to the movable body by using the image captured after the first period; and
estimating a route for sequentially moving through the future position predicted, and selecting a first pedestrian in moving the route as the first candidate.

6. The control method according to claim 1, wherein the predicting the future position of the first candidate with respect to the movable body includes:
removing the another pedestrian recognized to be distinguished from the specific person in the image captured in the first period from the pedestrians included in the image captured after the first period; and
selecting the first candidate from a remaining pedestrian who remains after the another pedestrian is excluded.

7. The control method according to claim 1, wherein the predicting the future position of the first candidate with respect to the movable body includes:
removing the another pedestrian recognized to be distinguished from the specific person in the image captured in the first period from the pedestrians included in the image captured after the first period; and
predicting a future position of a remaining pedestrian with respect to the movable body, the remaining pedestrian remaining after the another pedestrian is excluded; and
selecting, as the first candidate, a pedestrian closest to the movable body from the future position predicted.

8. The control method according to claim 1, further comprising after moving to the specific position in accordance with the future position predicted of the first candidate, recognizing the specific person by using an image including the first candidate.

9. The control method according to claim 1, wherein after moving to the specific position in accordance with the future position predicted of the first candidate, when determining that the specific person is absent by using an image including the first candidate,
predicting a future position of a second candidate with respect to the movable body by using the image captured after the first period, the second candidate being in the pedestrians in the surroundings of the movable body; and
controlling the traveling of the movable body to move to a specific position for recognizing the second candidate in accordance with the future position predicted of the second candidate.

10. The control method according to claim 1, wherein after moving to the specific position in accordance with the future position predicted of the first candidate, when determining that the specific person is absent by using an image including the first candidate,
moving to a hidden region to be hidden from the movable body, based on an occupancy grid map indicating a position of an obstacle in the surroundings of the movable body; and
recognizing the specific person by using an image captured after moving to the hidden region.

11. The control method according to claim 1, wherein after moving to the specific position in accordance with the future position predicted of the first candidate, when determining that the specific person is absent by using an image including the first candidate,
traveling to a predetermined position for finding the specific person; and
recognizing the specific person by using an image captured at the predetermined position.

12. The control method according to claim 11, wherein the predetermined position for finding the specific person is equal to or lower in density of the pedestrians than a predetermined threshold, and imaging of a region higher in the density of the pedestrians than the predetermined position is enabled at the predetermined position.

13. The control method according to claim 10, wherein after moving to the hidden region, when determining that the specific person is absent by using an image captured after moving to the hidden region,
traveling to a predetermined position for finding the specific person; and
recognizing the specific person by using an image captured at the predetermined position.

14. The control method according to claim 11, further comprising determining the predetermined position for finding the specific person by using a cost obtained by carrying out weighted addition of a second cost to a first cost of each position in the surroundings of the movable body in accordance with a distance from a pedestrian, the second cost including at least one of: a cost of each position in the surroundings of the movable body in accordance with brightness; a cost of each position in the surroundings of the movable body in accordance with density of pedestrians in a captured image; and a cost of each position in the surroundings of the movable body in accordance with a degree of an open space.

15. The control method according to claim 1, further comprising outputting a sound or a display indicating that the specific person is being searched for in response to being incapable of recognizing the specific person in the image captured after the first period.

16. A control device of a movable body that moves together with a specific person, the control device comprising:
a recognition unit configured to recognize the specific person and another pedestrian in pedestrians in surroundings of the movable body by using an image obtained by imaging the surroundings of the movable body in a first period;
in response to being incapable of recognizing the specific person in an image captured after the first period,
a prediction unit configured to predict a future position of a first candidate with respect to the movable body by using the image captured after the first period, the first candidate being in the pedestrians in the surroundings of the movable body; and
a controller configured to control traveling of the movable body to move from a current position to a specific position for recognizing the first candidate in accordance with the future position predicted of the first candidate.

17. A movable body that moves together with a specific person, the movable body comprising:
a recognition unit configured to recognize the specific person and another pedestrian in pedestrians in surroundings of the movable body by using an image obtained by imaging the surroundings of the movable body in a first period;
in response to being incapable of recognizing the specific person in an image captured after the first period,
a prediction unit configured to predict a future position of a first candidate with respect to the movable body by using the image captured after the first period, the first candidate being in the pedestrians in the surroundings of the movable body; and
a controller configured to control traveling of the movable body to move from a current position to a specific position for recognizing the first candidate in accordance with the future position predicted of the first candidate.

18. A non-transitory computer-readable storage medium storing a program for causing a computer to execute a control method of a movable body that moves together with a specific person, the control method comprising:
recognizing the specific person and another pedestrian in pedestrians in surroundings of the movable body by using an image obtained by imaging the surroundings of the movable body in a first period;
in response to being incapable of recognizing the specific person in an image captured after the first period,
predicting a future position of a first candidate with respect to the movable body by using the image captured after the first period, the first candidate being in the pedestrians in the surroundings of the movable body; and
controlling traveling of the movable body to move from a current position to a specific position for recognizing the first candidate in accordance with the future position predicted of the first candidate.
